(19) United States
(12) Patent Application Publication
(10) Pub. No.: US 2008/0121102 A1
(43) Pub. Date: May 29, 2008

(54) Two-Part Piston For a Combustion Engine

(76) Inventors: Rainer Scharp, Vaihingen (DE); Stefan Fischer, Ohmden (DE)

Correspondence Address: COLLARD & ROE, P.C., 1077 NORTHERN BOULEVARD, ROSLYN, NY, 11576, US

(21) Appl. No.: 11/791,807

(22) PCT Filed: Nov. 28, 2005
(86) PCT No.: PCT/DE05/02144

§ 371 Date: Jul. 11, 2007

(30) Foreign Application Priority Data
Nov. 30, 2004 (DE) 10 2004 057 625.4

(51) Int. Cl. F16J 1/04

(52) U.S. Cl. 92/208; 123/193.6; 92/186

(57) ABSTRACT

Disclosed is a two-part piston (1) for a combustion engine comprising a combustion chamber (16) in the piston head (13). The piston (1) is composed of a basic member (5) and a top part (6) that is screwed to the basic member (5). In order for the combustion pressure to act substantially upon the basic member (5), which is provided with great mechanical stability and load-bearing capacity relative to the pressure prevailing in the combustion chamber, the bottom part of the combustion chamber (16) is molded into the basic member (5), the top part (6) is configured in an essentially annular manner, and the top part (6) enlarges the combustion chamber (16) at the piston head end while delimiting the same in a radially outward direction similar to a collar (19).

The invention relates to a two-part piston for an internal combustion engine, in accordance with the preamble of claim 1.

A two-part piston having a combustion chamber in the piston crown is known from the patent DE 30 17 787 C2; it consists of an upper part and a base body, whereby the upper part is screwed together with the base body. In this connection, the combustion chamber is exclusively formed by the upper part, which is configured in very thin-walled manner in the region of the combustion chamber, so that the upper part cannot withstand any overly great mechanical stress, as it is exerted on the piston crown by the pressure prevailing in the combustion chamber.

It is the task of the present invention to avoid this disadvantage of the state of the art.

This task is accomplished with the characteristics standing in the characterizing part of the main claim. Practical embodiments of the invention are the object of the dependent claims.

In this connection, a piston that is able to withstand great mechanical and thermal stress is achieved, in that the combustion chamber is formed into the base body, for the most part, and that the upper part is configured in ring shape, so that the combustion pressure essentially acts on the base body, which has great mechanical strength, thereby increasing the ability of the piston to withstand mechanical stress.

The ability of the piston to withstand thermal stress is increased in that the parts of the piston that are most subject to thermal stress, the bowl edge and the top land, are formed by the upper part, which consists of forged aluminum or forged steel.

An exemplary embodiment of the invention will be described below, using the drawings. These show:

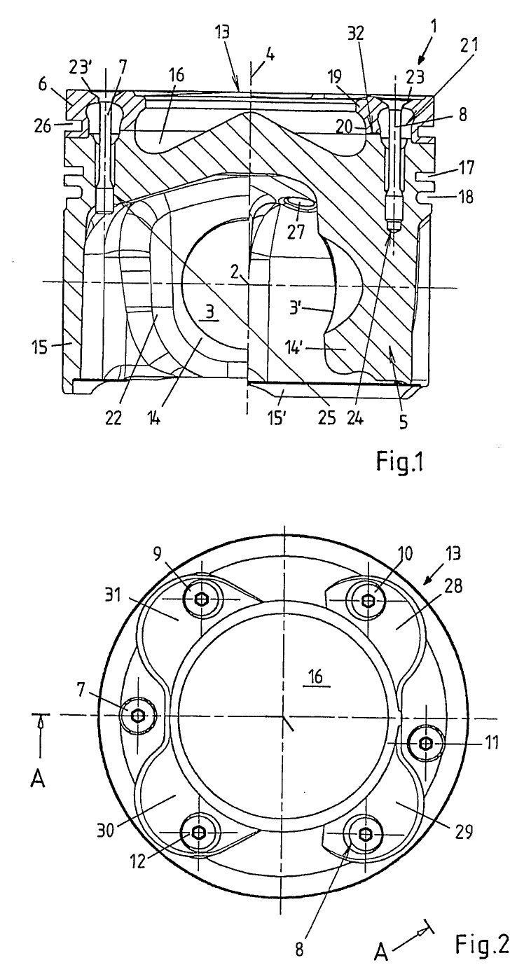

FIG. 1 a two-part piston for an internal combustion engine in a section along the bent line AA in FIG. 2, and

FIG. 2 a top view of the crown of the piston.

FIG. 1 shows a piston 1 for an internal combustion engine in section along a bent line AA in FIG. 2, whereby a sectional diagram consisting of two halves is obtained, the left half of which shows a sectional diagram of the piston 1 that lies in a sectional plane lying perpendicular to the longitudinal axis 2 of the pin bore 3 and on the axis 4 of the piston 1, and the right half of which represents a sectional diagram of the piston 1 that lies in a sectional plane offset by 45° to this, so that in this connection, a second pin bore 3′ is shown in slanted section.

The piston 1 consists of a base body 5 and an upper part 6, whereby the base body 5 and the upper part 6 are connected with one another by means of screws 7 to 12, disposed radially on the outside and uniformly distributed over the circumference. See also FIG. 2 in this regard.

The base body 5 has pin bosses 14 and 14′ on the underside facing away from the piston crown 13, each having a pin bore 3, 3′ and skirt elements 15, 15′ that connect the pin bosses 14, 14′ with one another. A combustion chamber 16 is formed into the piston crown 13. Furthermore, the base body 5 of the piston 1 has ring grooves 17 and 18 on its radial outside, close to the piston crown 13.

The upper part 6 is configured essentially in ring shape and is disposed on the base body 5 in such a manner that it enlarges the combustion chamber 16 formed into the base body 5 in the manner of a collar 19, on the piston crown side, and delimits it radially towards the outside, whereby the inside radius of the collar 19 decreases towards the top of the piston, so that an undercut 20 results in the combustion chamber 16.

Recesses are formed into the underside of the upper part 6, facing away from the piston crown, and radially on the outside into the top of the base body 5, which recesses have the same radius and thereby form a closed, ring-shaped cooling channel 21 after assembly of the upper part 6 onto the base body 5. To seal the cooling channel 21, a sealing element 32 can be disposed between upper part 6 and base body 5. The cooling channel 21 is connected with the piston interior 22 by way of oil inflow openings and oil outflow openings 27.

The screws 7 to 12 that connect the upper part 6 with the base body 5 are guided through conically shaped bores 23, 23′ of the upper part 6, on the piston crown side, and screwed in, in part into dead-end holes having an inside thread 24, in part into passage bores 25 having an inside thread. In this connection, the screws 7 to 12 are guided through the cooling channel 21, which brings with it a saving of space, particularly in the case of smaller pistons.

The base body 5 is made from steel or from aluminum, whereby at first, a blank is produced using a forcing method or a casting method. Subsequently, the base body 5 is completed from the blank, by means of a cutting production method (lathing, milling). The upper part 6 is produced from steel or from aluminum, using a forging method, whereby again, a blank is first produced, which is finished by means of a cutting production method. In this way, it is assured that the upper part 6 has sufficient strength so that it can perform the function of a friction-wear-resistant ring insert after a groove 26 has been machined into its radial outside, for a compression ring not shown in the figures.

The piston 1 according to the invention, having the ring-shaped upper part 6 and having the combustion chamber 16 formed into the base body 5, for the most part, has the advantage, for one thing, that the combustion pressure acts essentially on the base body 5, which has great mechanical strength and the ability to withstand stress, with regard to the pressure that prevails in the combustion chamber. For another thing, the upper part 6 can be produced in price-advantageous manner, because of its simple ring shape. Furthermore, the bowl edge and the top land, which are the parts of the piston 1 subject to the greatest thermal stress, are formed by the upper part 6, produced using a forging method and therefore able to withstand great stress, so that in total, a piston that is well able to withstand great thermal stress is obtained.

FIG. 2 shows a top view of the piston crown 13, which illustrates the distribution of the screws 7 to 12. Also, the combustion chamber 16 and valve recesses 28 to 31 worked into the piston crown 13 can be seen.

### REFERENCE SYMBOL LIST

1 piston
2 longitudinal axis of the pin bore 3
3 pin bore
4 axis of the piston 1
5 base body of the piston 1
6 upper part of the piston 1
7 to 12 screw
13 piston crown
14, 14′ pin boss
15, 15′ skirt element
16 combustion chamber
17, 18 ring groove
19 collar
20 undercut
21 cooling channel
22 piston interior
23, 23′ bore
24 dead-end hole
25 passage bore
26 groove
27 oil inflow opening, oil outflow opening
28 to 31 valve recess
32 sealing element

1-5. (canceled)

6: Two-part piston (1) for an internal combustion engine, having a combustion chamber (16) in the piston crown (13), consisting
of a base body (5)
having pin bosses (14, 14′) each having a pin bore (3, 3′), and
having skirt elements (15, 15′) that connect the pin bosses (14, 14′) with one another, and
of an upper part (6) disposed on the top of the base body (5), facing away from the pin bosses (14, 14′), and screwed together with the base body (5) by means of screws (7 to 12),
whereby the lower part of the combustion chamber (16) is formed into the base body (5),
whereby the upper part (6) is configured essentially in ring shape and enlarges the combustion chamber (16) in the manner of a collar (19), on the piston crown side, and delimits it radially towards the outside, and
whereby recesses are formed into the underside of the upper part (6), and into the top of the base body (5), which recesses result in a closed, ring-shaped cooling channel (21) after assembly of the upper part (6) onto the base body (5),
wherein
the screws (7 to 12) are guided through bores (23, 23′) of the upper part (6), on the piston crown side, and through the cooling channel (21), and screwed in, in part into dead-end holes (24) of the base body (5) having an inside thread, and in part into passage bores (25) of the base body (5) having an inside thread.

7: Two-part piston (1) for an internal combustion engine according to claim 6, wherein the upper part (6) is produced using a forging method.

8: Two-part piston (1) for an internal combustion engine according to claim 6, wherein the upper part (6) consists of steel.

9: Two-part piston (1) for an internal combustion engine according to claim 6, wherein the upper part (6) consists of aluminum.

10: Two-part piston (1) for an internal combustion engine according to claim 6, wherein a groove (26) for a compression ring is formed into the radial outside of the upper part (6).
